(19) United States
(12) Patent Application Publication
(10) Pub. No.: US 2012/0151716 A1
(43) Pub. Date: Jun. 21, 2012

(54) HINGE DEVICE

(75) Inventor: Lars Holstensson, Vaxjo (SE)

(73) Assignee: HOLSTENSSON DESIGN AB, Växjö (SE)

(21) Appl. No.: 13/381,059

(22) PCT Filed: Mar. 11, 2010
(86) PCT No.: PCT/SE2010/050274

§ 371 Date: Mar. 2, 2012

(30) Foreign Application Priority Data
Jul. 1, 2009 (SE) 0900898-8

(51) Int. Cl. E05D 1/00

(52) U.S. Cl. 16/224

(57) ABSTRACT

A hinge device has a first part and a second part, which are intended to be attached to a door frame and a door, respectively. The first part and the second part are rigidly connected to each other and have each a tubular housing, whose centre axis defines a first hinge axis and which accommodates two balls, an axially displaceable locking member arranged axially inwardly of each ball, a compression spring arranged between and cooperating with each ball and the associated locking member, and an eccentric located between the two locking members and cooperating therewith. Each eccentric is rotatably carried about a transverse axis in the respective housing and rotatable between an initial position, in which the two associated locking members are located in an axially inner position and the two associated balls are located in a position slightly projecting from the housing, in which position they are held biased by the respective compression spring, and an active position, in which the two associated locking members are located in an axially outer position, in which they abut against the respective ball axially locking it in the projecting position.

### TECHNICAL FIELD

The present invention relates to a hinge device intended to be mounted on a first element, such as a door frame, and on a second element, such as a door, to enable pivoting of the two elements relative to each other, the hinge device having a first part, which is to be attached to the first element, and a second part, which is intended to be attached to the second element.

### BACKGROUND ART

Various designs of hinge devices of this kind are known in the art. In prior-art hinge devices, the two parts are generally provided in the form of separate parts, which upon use of the hinge device become articulatedly interconnected or which have previously been articulatedly interconnected by means of a hinge pin and a hinge sleeve, which form a pivot located between the mutually pivotable elements, such as a door panel and a door frame, about which said elements are pivotable.

### SUMMARY OF THE INVENTION

The object of the present invention is to provide a hinge device which, when mounted on the two elements, is almost completely concealed therein and thus impossible to manipulate and which can be mounted on and dismounted from the two elements in an extremely simple manner.

This object is achieved by a hinge device which is of the type stated by way of introduction and which according to the present invention is characterised in that

the first part and the second part are rigidly connected to each other,

the first part has a tubular first housing, whose centre axis defines a first hinge axis and which accommodates two balls, which are located at either end of the housing, an axially displaceable locking member arranged axially inwardly of each ball, a compression spring arranged between and cooperating with each ball and the associated locking member, and an eccentric located between the two locking members and cooperating therewith, and

the second part has a tubular second housing, whose centre axis defines a second hinge axis parallel to the first hinge axis and which accommodates two balls, which are located at either end of the housing, an axially displaceable locking member arranged axially inwardly of each ball, a compression spring arranged between and cooperating with each ball and the associated locking member, and an eccentric located between the two locking members and cooperating therewith,

each eccentric being rotatably carried about a transverse axis in the respective housing and rotatable between an initial position, in which the two associated locking members are located in an axially inner position and the two associated balls are located in a position projecting slightly from the housing, in which position they are held biased by the respective compression spring, and an active position, in which the two associated locking members are located in an axially outer position, in which they abut against the respective ball axially locking it in the projecting position, and

the first part and the second part being intended, when the eccentric is in the initial position, to be inserted in a recess in the first and second elements, respectively, such that the balls thereof engage with mutually opposite depressions in the respective recess, the balls being axially lockable in the respective depression by rotating the eccentric into the active position.

By virtue of the fact that the two parts of the hinge device are not interconnected by a single pivot unit, which would have been positioned between the mutually pivotable elements, but instead have two pivot units (housings with components disposed therein) which, as said two parts are fully inserted in the recess in the respective element, will also be positioned inside the respective element, the hinge device is completely concealed during use and therefore impossible to manipulate. The hinge device is mounted by simply inserting its two parts in the respective recess and securing them in this position by turning the respective eccentric to its active position. The dismounting is equally simple and is realized by turning the respective eccentric to its initial position and subsequently removing the two parts from the recesses.

The first part and the second part are preferably formed in one piece.

In a preferred embodiment, the first part and the second part are formed from a sheet-metal plate, which is bent into a U-shape, the two U-legs being bent over at their free ends for forming the tubular housings.

Preferably, the dimensions of the sheet-metal plate are such that, when the first part is inserted in the recess in the first element and the back of the web portion of the U-shaped sheet-metal plate bears against a side wall of the recess, the balls of the first part engage with the mutually opposite depressions in the recess, and that, when the second part is inserted in the recess in the second element and the back of the web portion of the U-shaped sheet-metal plate bears against a side wall of the recess, the balls of the second part engage with the mutually opposite depressions in the recess.

Furthermore, the dimensions of the sheet-metal plate are preferably such that the length of the U-legs of the sheet-metal plate bent into a U-shape, as measured from the back of said web portion to the centre axis of the respective housing, equals the distance from the centre of the depression in the recess of the corresponding element to the opening of the recess plus the thickness of the sheet-metal plate.

Conveniently, the two U-legs have the same length.

In a preferred embodiment, the hinge device further has two U-shaped brackets, one of which is intended to be inserted and fixed in the recess in the first element and the other of which is intended to be inserted and fixed in the recess in the second element, the legs of each bracket being provided with oppositely arranged holes which, when the bracket is in its inserted and fixed state, define said depressions in the respective recess.

Conveniently, the tubular housings have end portion upsets designed to retain the balls therein.

### BRIEF DESCRIPTION OF THE DRAWINGS

FIG. 1 is a perspective view of a hinge device according to the invention and an upper portion of a pivotable element in the form of a door.

FIG. 2 is an exploded perspective view of a main body and its associated components which form part of the hinge device according to FIG. 1.

FIGS. 3A and 3B are longitudinal sectional views of a housing which forms part of the main body shown in FIG. 2 in two different positions with respect to the components mounted therein, FIG. 3A illustrating an initial position and FIG. 3B illustrating an active position.

FIG. 4 is a perspective view showing one of two brackets included in the hinge device according to FIG. 1.

FIG. 5 shows the hinge device according to FIG. 1 when positioned between a door and a door frame, which are shown in horizontal section.

FIGS. 6-10 illustrate the functioning of the hinge device and show the door in different pivoting stages relative to a door frame.

### DESCRIPTION OF A PREFERRED EMBODIMENT

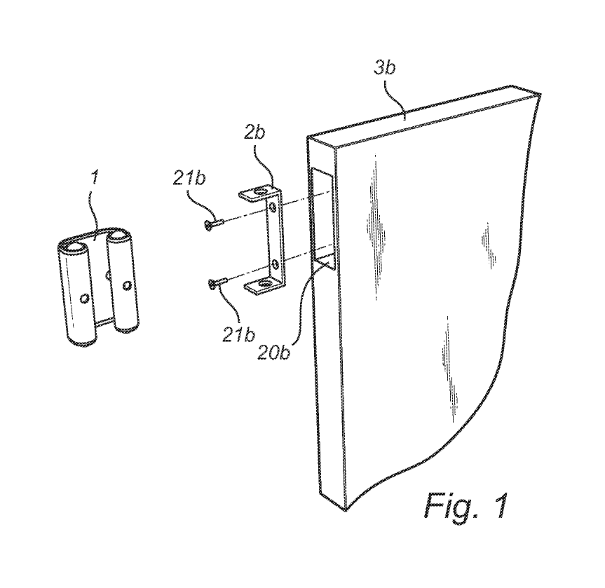

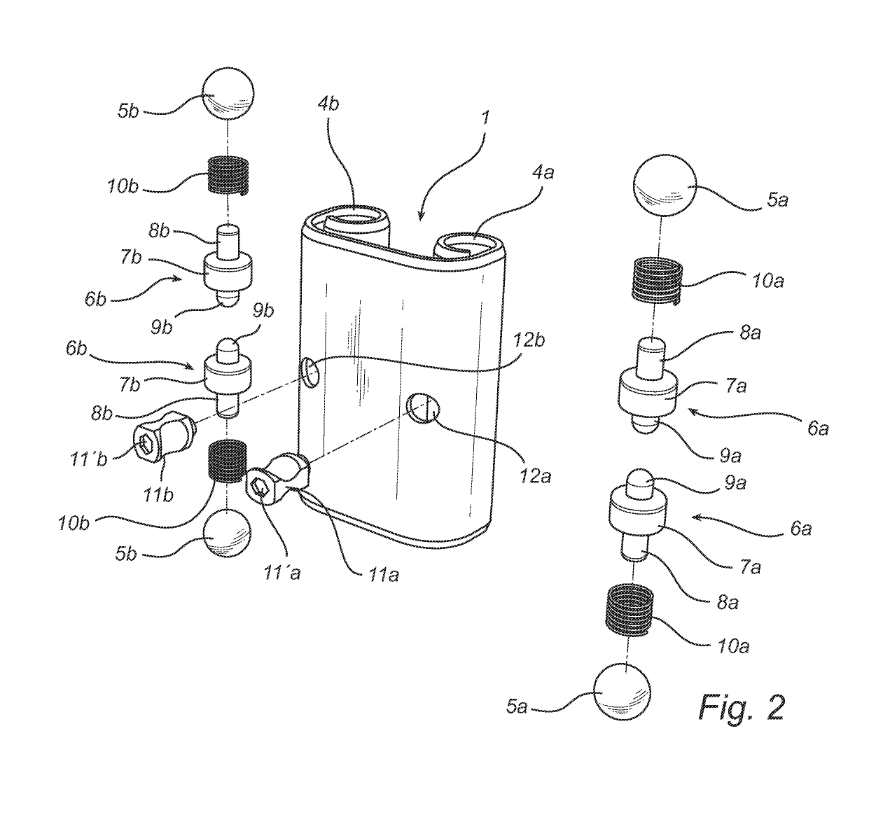

The hinge device shown in FIG. 1 comprises a main body 1 and components disposed therein, which will be described in more detail below, as well as two U-shaped brackets 2a and 2b, only one (2b) of which is shown in FIG. 1

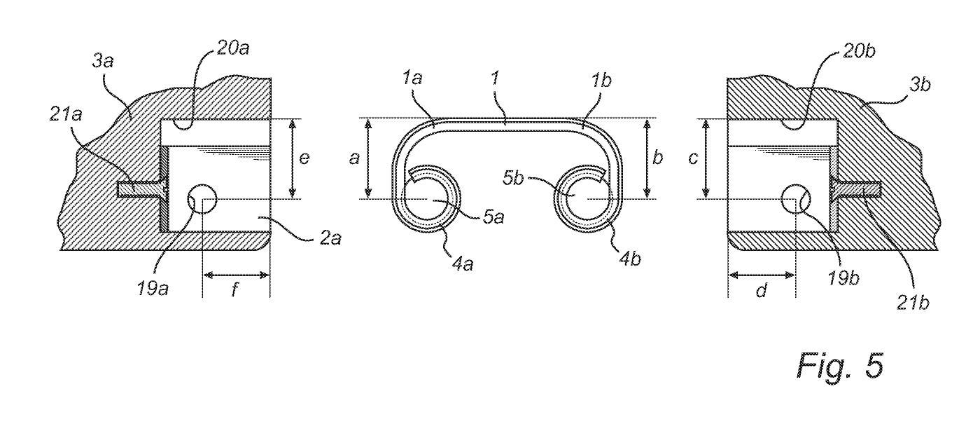

The main body 1 can be divided into a first part 1a and a second part 1b (FIG. 5). It should be noted, however, that these two parts 1a and 1b are rigidly connected to each other by being formed in one piece. The first part 1a is intended to be attached to a first element 3a, which in the shown embodiment is a door frame, whereas the second part 1b is intended to be attached to a second element 3b, which in the shown embodiment is a door, so as to enable pivoting of the two elements 3a and 3b relative to each other.

The first part 1a and the second part 1b are formed from a single sheet-metal plate, which is bent into a U-shape, the two U-legs being bent over at their free ends for forming a respective tubular housing 4a, 4b having a substantially circular cross section.

The first part 1a thus has a tubular first housing 4a, whose centre axis defines a first hinge axis. The housing 4a accommodates two balls 5a, whose diameter substantially corresponds to the inner diameter of the tubular housing 4a and which are located at either end of the housing 4a.

The housing 4a further accommodates an axially displaceable locking member 6a arranged axially inwardly of each ball 5a and having a circular central portion 7a, whose diameter substantially corresponds to the inner diameter of the housing 4a, an axially outwardly extending lug 8a designed to cooperate with the respective ball 5a and an axially inwardly extending lug 9a with a rounded end.

A compression spring 10a is arranged between each ball 5a and the respective locking member 6a and abuts at one end against the ball 5a and at the other end against the central portion 7a of the locking member 6a.

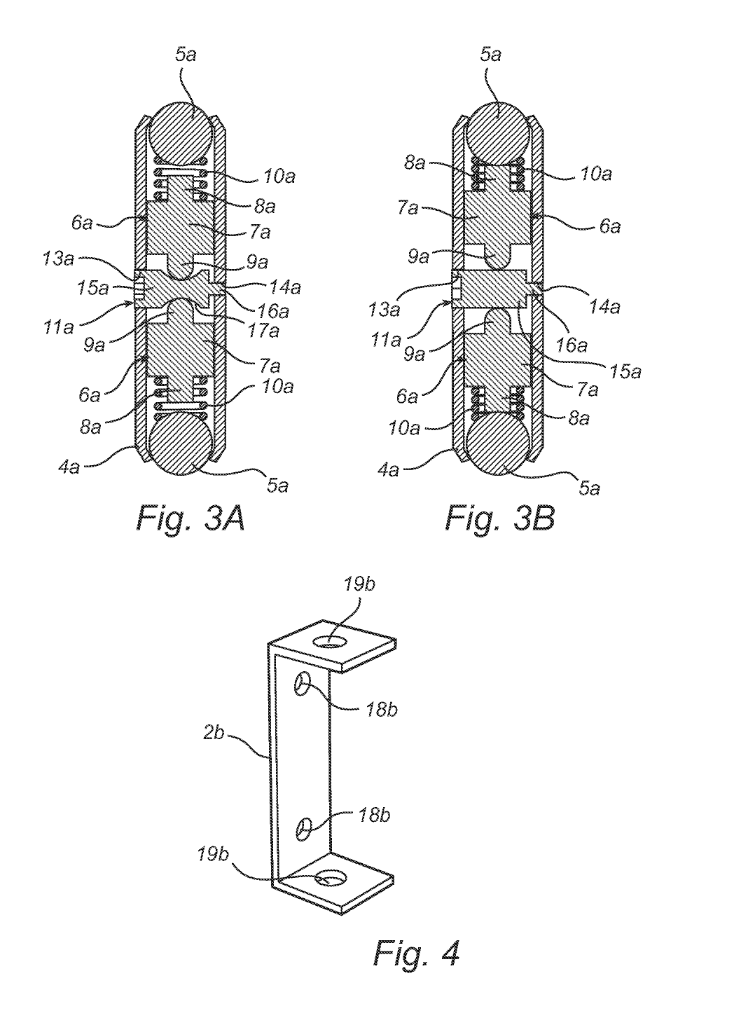

Finally, the housing 4a accommodates an eccentric 11a, which is arranged between the two locking members 6a for cooperating therewith. The eccentric 11a is rotatable about a transverse axis, which is defined by oppositely arranged holes 12a, 13a and 14a in the web portion of the U-shaped sheet-metal plate and the tube wall of the tubular housing 4a. The hole 12a in the web portion and the hole 13a in the tubular wall closest to the web portion have a larger diameter than the hole 14a in the tube wall that is located diametrically opposite the hole 13a. The eccentric 11a has a substantially cylindrical portion 15a, which has the same diameter as the hole 13a and which is carried therein, and a lug 16a which projects from the other end of the portion 15a and which has the same diameter as the hole 14a and is carried therein. The eccentric 11a has in its cylindrical portion 15a a substantially circumferential eccentric groove 17a with which the two locking members 6a engage by means of the rounded end of the respective lug 9a (see FIGS. 3A and 3B). The groove 17a has two diametrically opposed deep portions and two diametrically opposed shallow portions.

The first part 1a and the second part 1b have mirror symmetry with respect to each other. The second part 1b thus has a tubular second housing 4b, whose centre axis defines a second hinge axis parallel to the first hinge axis. Like the first housing 4a, the second housing 4b accommodates two balls 5b, two locking members 6b, two compression springs 10b and an eccentric 11b. These components 5b, 6b, 10b and 11b are designed and arranged in the same manner as the corresponding components 5a, 6a, 10a and 11a, respectively, described above and function in the same way. Accordingly, the locking member 6b has a circular central portion 7b and projecting lugs 8b and 9b. The eccentric 11b has a substantially cylindrical portion 15b provided with a substantially circumferential, eccentric groove 17b, and a projecting lug 16b and is rotatable about a transverse axis, which is defined by oppositely arranged holes 12b, 13b and 14b in the web portion of the U-shaped sheet-metal plate and the tube wall of the tubular housing 4b.

Each of the tubular housings 4a, 4b has end portion upsets designed to retain the balls 5a, 5b therein.

The function of these components will now be described with reference to FIGS. 3A and 3B, which show the housing 4a of the first part 1a in longitudinal section. Once more, it should be noted that the components of the second part 1b work in the same manner.

FIG. 3A shows an initial position, in which the rotatable eccentric 11a is located in a first position of rotation (initial position), in which the two lugs 9a of the locking members engage, by means of their rounded ends, with the diametrically opposed deep portions of the groove 17a, the locking members 6a being thus in an axially inner position. In the initial position, the compression springs 10a moves the respective ball 5a into a position slightly projecting from the respective end of the housing 4a where it abuts against the respective end portion upset. As the eccentric 11a is rotated to the second position of rotation shown in FIG. 3B (the active position), the locking members 6a are displaced axially outwards to an axially outer position during compression of the compression springs 10a. In the active position, the two lugs 9a of the locking members engage, by means of their rounded ends, with the diametrically opposed shallow portions of the groove 17a, the ends of the two lugs 8a of the locking members abutting against the respective ball 5a axially locking it in the projecting position, i.e. preventing it from being pushed in.

The eccentric 11a (11b) is rotatable by means of a hexagon wrench which, via the hole 12a (12b) in the web portion of the U-shaped sheet-metal plate, is inserted in a hexagon recess 11′a (11′b) formed in the end surface of the substantially cylindrical portion 15a (15b).

The hinge device further comprises, as mentioned above, two brackets 2a and 2b, which are identical and one 2b of which is shown in greater detail in FIG. 4.

The shown bracket 2b is U-shaped and has in its web portion two mounting holes 18b and in each of its legs a hole 19b. The holes 19b are intended to cooperate with the two balls 5b of the second part 1b and to form depressions for receiving said balls. The bracket 2b is to be inserted in a recess 20b formed in the edge surface of the door 3b and to be fixed in said recess by means of screws 21b which extend through the mounting holes 18b.

The other bracket 2a is intended to be inserted in a recess 20a formed in the door frame 3a and to be fixed therein by means of screws 21a, which extend through its mounting holes 18a. The leg holes 19a of the bracket 2a are intended to cooperate with the two balls 5a of the first part 1a and to form depressions for receiving said balls. The first part 1a is intended to be inserted in the recess 20a of the door frame 3a, or more particularly in the bracket 2a positioned therein. Upon insertion of the first part 1a, which occurs with the eccentric 11a in the initial position, the balls 5a are pushed into the housing 4a in a spring-biased manner. When the balls 5a reach a position opposite the holes 19a in the legs of the bracket 2a, they are again pushed out by the compression springs 10a to the projecting position for engaging with the holes 19a. The first part 1a is fixed in the recess 20a by rotating the eccentric 11a to the active position.

The second part 1b is intended to be inserted and fixed in the recess 20b of the door 3b or more particularly in the bracket 2b positioned therein in the manner described above with respect to the first part 1a.

In the shown embodiment of the hinge device, the U-legs of the first part 1a and the second part 1b have a length a and b, respectively, as measured from the back side of the web portion to the centre axis of the respective housing 4a and 4b, that equals the distance e and c, respectively, between the side wall of the respective recess 20a and 20b which bears against the back side of the web portion and the centre of the holes 19a and 19b, respectively, of the respective bracket 2a and 2b inserted and fixed in the respective recess 20a and 20b. Moreover, the distance f and d, respectively, between the centre of the holes 19a and 19b, respectively, of the respective bracket 2a and 2b inserted and fixed in the respective recess 20a and 20b and the opening of the respective recess equals the length of the leg length a and b, respectively, minus the thickness of the sheet-metal plate. In the shown embodiment, the two U-legs have the same length, i.e. a=b.

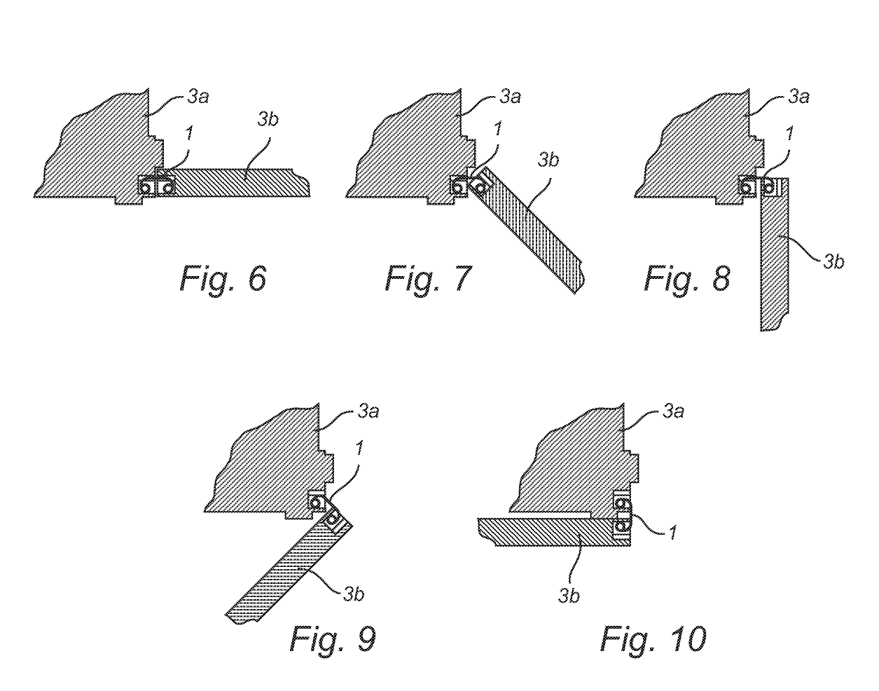

FIGS. 6-10 show the hinge device when positioned on the door frame 3a and the door 3b, which means that the two brackets 2a and 2b are inserted and fixed in the respective recess 20a and 20b and that the first part 1a is inserted in the recess 20a in the frame 3a and the second part 1b is inserted in the recess 20b in the door 3b, the eccentrics 11a and 11b of the two housings 4a and 4b being moved by means of rotation to their active position, whereby the balls 5a and 5b engage in an axially locked manner with the holes 19a and 19b, respectively in the respective bracket 2a and 2b.

FIG. 6 shows the door 3b in an initial position, in which its pivoting angle relative to the frame 3a is 0°. When the door 3b is pivoted from the initial position, it pivots about the second hinge axis defined by the centre axis of the second housing 4b. This is illustrated in FIG. 7 by a pivoting position in which the pivoting angle of the door is 45°. This pivoting about the second hinge axis is continued until the door reaches the pivoting position shown in FIG. 8, in which the pivoting angle is 90°. Upon continued pivoting of the door 3b from the 90 degree position, the hinge devices pivots relative to the frame 3a about the first hinge axis defined by the centre axis of the first housing 4a. This is illustrated in FIG. 9 by a pivoting position in which the pivoting angle of the door is 135°. The door 3b can be pivoted further to an end position, which is shown in FIG. 10 and in which its pivoting angle is 180°.

It should be noted that the latter pivoting angle, i.e. the 180 degree end position, is the position in which the main body 1 inserted in the recesses 20a and 20b is fixed therein by the hexagon wrench mentioned above being inserted, via the holes 12a and 12b in the web portion, whose back side is fully exposed when the door 3b is in the end position (see FIG. 10), in the hexagon recess 11′a, 11′b of the respective eccentric 11a, 11b for rotating the eccentric to the active position.

It will be appreciated that the hinge device described above can be modified in various ways within the scope of the claims. Accordingly, the separate locking members 6a and 6b may, for example, be replaced by a locking member formed integrally in one piece with the respective eccentric 11a, 11b, which means that the eccentric acts directly on the balls 5a, 5b and that the springs 10a, 10b act between the balls and the eccentric.

1. A hinge device intended to be mounted on a first element, such as a door frame, and on a second element, such as a door, to enable pivoting of the two elements relative to each other, the hinge device having a first part, which is intended to be attached to the first element, and a second part, which is intended to be attached to the second element,
wherein
the first part and the second part are rigidly connected to each other,
the first part has a tubular first housing, whose centre axis defines a first hinge axis and which accommodates two balls, which are located at either end of the housing, an axially displaceable locking member arranged axially inwardly of each ball, a compression spring arranged between and cooperating with each ball and the associated locking member, and an eccentric located between the two locking members and cooperating therewith, and
the second part has a tubular second housing, whose centre axis defines a second hinge axis parallel to the first hinge axis and which accommodates two balls, which are located at either end of the housing, an axially displaceable locking member arranged axially inwardly of each ball, a compression spring arranged between and cooperating with each ball and the associated locking member, and an eccentric located between the two locking members and cooperating therewith,
each eccentric being rotatably carried about a transverse axis in the respective housing and rotatable between an initial position, in which the two associated locking members are located in an axially inner position and the two associated balls are located in a position projecting slightly from the housing, in which position they are held biased by the respective compression spring, and an active position, in which the two associated locking members are located in an axially outer position, in which they abut against the respective ball axially locking it in the projecting position, and
the first part and the second part being intended, when the eccentric is in the initial position, to be inserted in a recess in the first and second elements, respectively, such that the balls thereof engage with mutually opposite depressions in the respective recess, the balls being axially lockable in the respective depression by rotating the eccentric into the active position.

2. A hinge device according to claim 1, wherein the first part and the second part are formed in one piece.

3. A hinge device according to claim 2, wherein the first part and the second part are formed from a sheet-metal plate, which is bent into a U-shape, the two U-legs being bent over at their free ends for forming the tubular housings.

4. A hinge device according to claim 3, wherein the dimensions of the sheet-metal plate are such that, when the first part is inserted in the recess in the first element and the back of the web portion of the U-shaped sheet-metal plate bears against a side wall of the recess, the balls of the first part engage with the mutually opposite depressions in the recess, and that, when the second part is inserted in the recess in the second element and the back of the web portion of the U-shaped sheet-metal panel bears against a side wall of the recess, the balls of the second part engage with the mutually opposite depressions in the recess.

5. A hinge device according to claim 4, wherein the dimensions of the sheet-metal plate further are such that the length of the two U-legs of the sheet-metal plate bent into a U-shape, as measured from the back of said web portion to the centre axis of the respective housing, equals the distance from the centre of the depression in the recess of the corresponding element to the opening of the recess plus the thickness of the sheet-metal plate.

6. A hinge device according to claim 3, wherein the two U-legs have the same length.

7. A hinge device according to claim 1, which further has two U-shaped brackets, one of which is intended to be inserted and fixed in the recess in the first element and the other of which is intended to be inserted and fixed in the recess in the second element, the legs of each bracket being provided with oppositely arranged holes which, when the bracket is in its inserted and fixed state, define said depressions in the respective recess.

8. A hinge device according to claim 1, wherein the tubular housings have end portion upsets designed to retain the balls therein.
